(19) United States
(12) Patent Application Publication
(10) Pub. No.: US 2016/0022526 A1
(43) Pub. Date: Jan. 28, 2016

(54) MOBILE CART AND MEDICAL CART

(71) Applicant: MELTEN corporation, Taipei City (TW)

(72) Inventors: Shih-Huang Chen, Taipei City (TW); Hsiang-Wei Huang, Taipei City (TW)

(21) Appl. No.: 14/631,858

(22) Filed: Feb. 26, 2015

(30) Foreign Application Priority Data
Jul. 28, 2014 (TW) 103125696

(51) Int. Cl. A61G 12/00; A47B 95/00; A47B 96/02; A47B 81/00

(52) U.S. Cl. CPC A61G 12/001; A47B 81/00; A47B 95/00; A47B 96/025; A47B 2097/006

(57) ABSTRACT

A mobile cart includes a cabinet, wheels, drawers and an illumining unit. The wheels are disposed on a bottom of the cabinet. The drawers are disposed in the cabinet and configured to be pulled out of the cabinet. The drawers includes compartment drawers. The illumining unit is disposed on a top of the cabinet and includes a compartment drawer illumining module, wherein the compartment drawer illumining module is configured to illumine any one of the compartment drawers being pulled out of the cabinet.

### CROSS-REFERENCE TO RELATED APPLICATION

This application claims the priority benefit of Taiwan application serial no. 103125696, filed on Jul. 28, 2014. The entirety of the above-mentioned patent application is hereby incorporated by reference herein and made a part of this specification.

### BACKGROUND

1. Technical Field

The disclosure is related to a mobile cart and particularly to a movable cart having an illumining unit.

2. Background

Mobile carts are widely used in various working places such as the vehicle repair and maintenance facility, the nursing station and so on, due to the advantages of saving working time, high mobility, etc. To the mobile cart used in the nursing station, since the mobile cart has wheels for movement and a plurality of drawers for containing drugs and medical materials, time waste of the nursing personnel to go back and forth between the nursing station and the ward is dramatically reduced. However, contents in the drawer pulled out of the mobile cart may not be distinguished clearly when there is no sufficient illumination in the working environment, which obstructs the work.

To the mobile cart used in the nursing station, when the mobile cart is moved to the ward where patients rest in the night, since the environment of the ward is dark, the nursing personnel needs to switch on the illuminating device of the ward and thus disturbs the rest of all the patients in the ward. Instead of switching on the illuminating device of the ward, the nursing personnel requires a flash light for illumination or needs to look at the drawer of the mobile cart much close, which causes inconvenience of work. In the situation of insufficient illumination, the nursing personnel may be incapable of distinguishing the drugs or medical materials in the drawer of the mobile cart clearly, which increases risk of medical negligence. More seriously, drugs may be taken by mistake to endanger lives of patients.

### SUMMARY

The disclosure provides a mobile cart which facilitates users to work in an environment without sufficient illumination.

An embodiment of the disclosure provides a medical cart including a cabinet, a plurality of wheels, a plurality of drawers, a keyboard tray illumining module and a sensing unit. The wheels are disposed on a bottom of the cabinet. The drawers are disposed in the cabinet and configured to be pulled out of the cabinet, wherein the drawers comprise a keyboard tray and a plurality of compartment drawers, and the compartment drawers are located below the keyboard tray for accommodating a plurality of pill boxes. The keyboard tray illumining module is disposed on the cabinet and configured to illumine the keyboard tray pulled out of the cabinet, wherein an effective illumining range of the keyboard tray illumining module is located in the surrounding of the keyboard tray being pulled out of the cabinet. The sensing unit is disposed on the cabinet for sensing whether the keyboard tray is pulled out of the cabinet or not, wherein the sensing result of the sensing unit is a basis for switching on the keyboard tray illumining module or not, and when the sensing unit senses the keyboard tray being pulled out of the cabinet, the keyboard tray illumining module is switched on to illumine the keyboard tray being pulled out of the cabinet.

Another embodiment of the disclosure provides a mobile cart including a cabinet, a plurality of wheels, a plurality of drawers and an illumining unit. The wheels are disposed on a bottom of the cabinet. The drawers are disposed in the cabinet and configured to be pulled out of the cabinet, wherein the drawers comprise a plurality of compartment drawers. The illumining unit is disposed on a top of the cabinet and comprises a compartment drawer illumining module, wherein the compartment drawer illumining module is configured to illumine any one of the compartment drawers being pulled out of the cabinet. Furthermore, the illumining unit may further comprise a keyboard tray illumining module, and the drawers may further comprise a keyboard tray. The keyboard tray illumining module is configured to illumine the keyboard tray being pulled out of the cabinet.

According to the aforementioned embodiments of the disclosure, the drawer being pulled out of the cabinet can be illumined by the illumining unit in an environment without sufficient illumination, such that the user can see the contents in the drawer clearly to ensure the work can be normally performed. It is noted that the mobile cart may further include a sensing unit. The sensing unit senses whether the drawer (e.g. the keyboard tray or one of the compartment drawers) is pulled out of the cabinet or not, for switching on the illumining unit to illumine the drawer being pulled out of the cabinet accordingly. The illumining unit may include a keyboard tray illumining module and a compartment drawer illumining module for illumining the keyboard tray and the compartment drawers respectively.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a side view of a mobile cart according to an embodiment of the disclosure.

FIG. 2 is a side view showing a keyboard tray illumining module of the mobile cart illumining a keyboard tray.

FIG. 3 is a side view showing a compartment drawer illumining module of the mobile cart illumining one of the compartment drawers.

### DETAILED DESCRIPTION OF DISCLOSED EMBODIMENTS

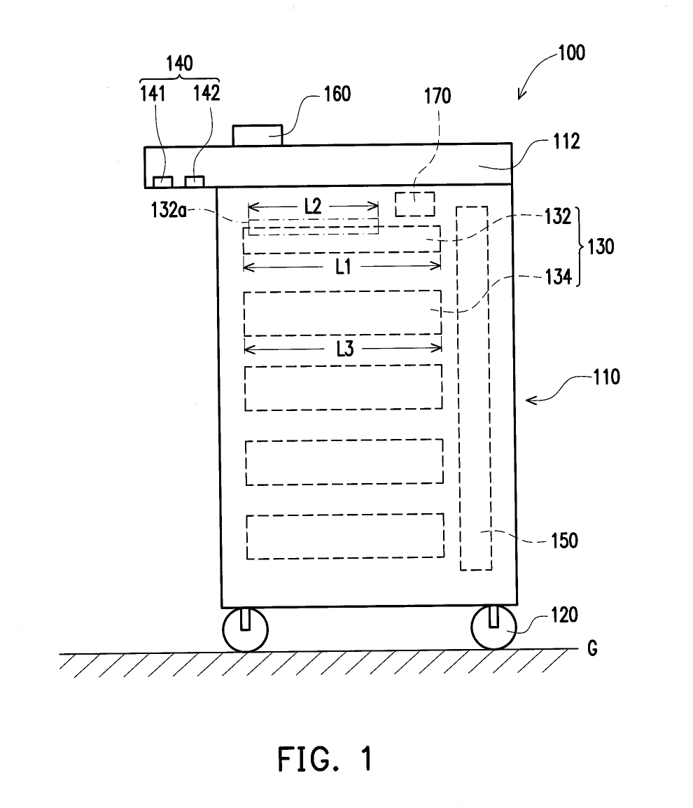

FIG. 1 is a side view of a mobile cart according to an embodiment of the disclosure. Referring to FIG. 1, in the present embodiment, the mobile cart 100 may be a medical cart, a tool cart, etc., and the disclosure provides no limitation to the application of the mobile cart 100. The mobile cart 100 includes a cabinet 110, a plurality of wheels 120, a plurality of drawers 130, an illumining unit 140, a sensing unit 150 and a switch unit 160.

The cabinet 110 has a working platform 112 located on a top of the cabinet 110 to provide the user with a working plane or carry a screen. The wheels 120 are disposed on the bottom of the cabinet 110, such that the mobile cart 100 can be moved by an external force.

The drawers 130 are disposed in the cabinet 110 for carrying or accommodating things, and are adapted to be pulled out of the cabinet 110 by the user to use or take out the things therein. Specifically, in the present embodiment, the drawers 130 include a keyboard tray 132 and a plurality of compartment drawers 134. The keyboard tray 132 and the compartment drawers 134 are all disposed in the cabinet 110, and can be pulled out of the cabinet 110. In addition, the working platform 112 of the cabinet 110 is located above the keyboard tray 132, and the keyboard tray 132 is located on the top of the cabinet 110. A keyboard and/or a mouse may be disposed on the keyboard tray 132 for the user to input commands for operating a computer. The compartment drawers 134 are located below the keyboard tray 132 for disposing pill boxes or accommodating things such as medical materials, components, etc.

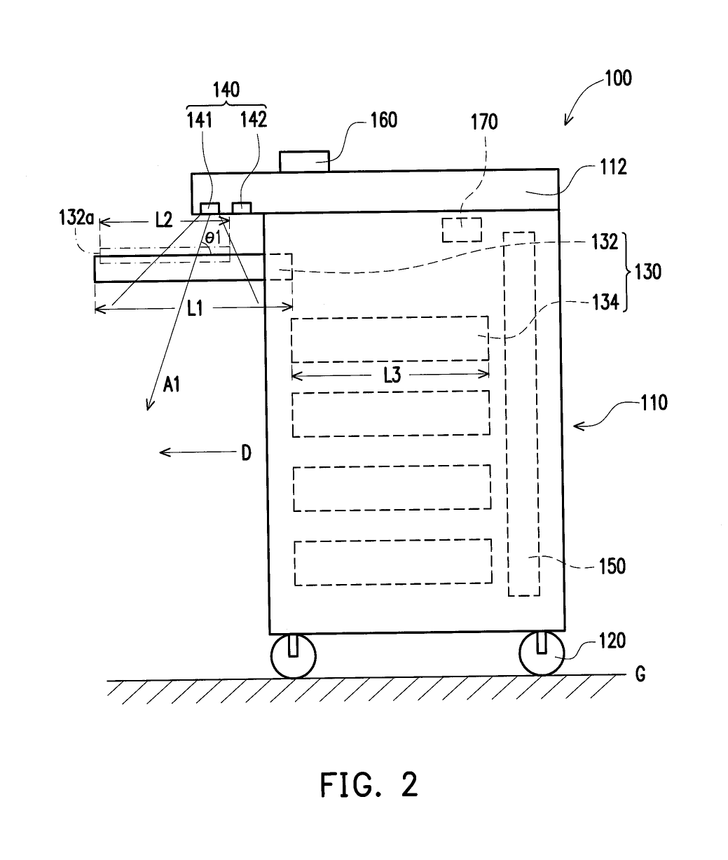

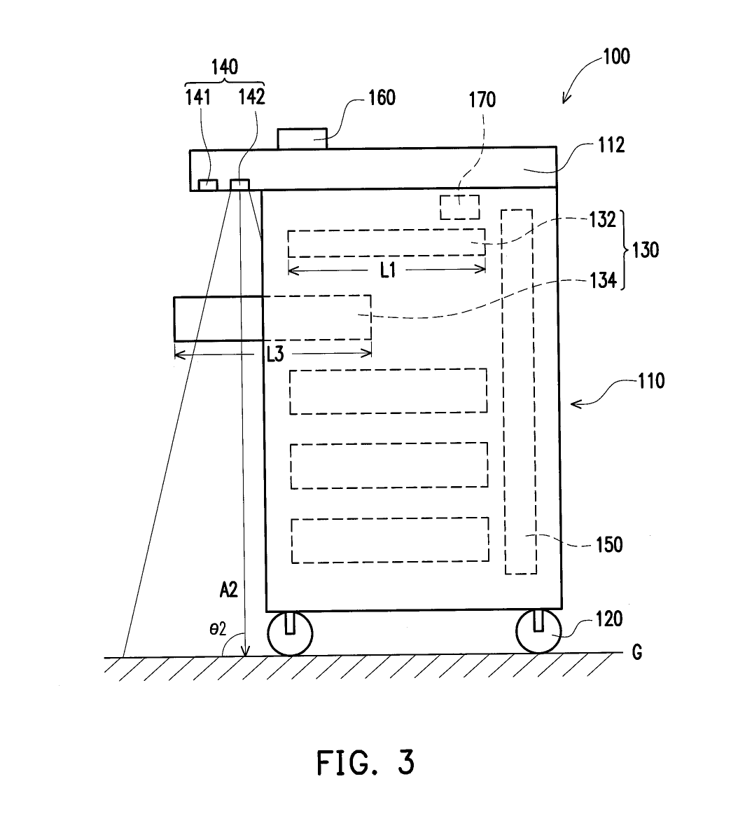

The illumining unit 140 is disposed on the top of the cabinet 110 to illumine the drawer 130 being pulled out of the cabinet 110. In detail, the illumining unit 140 includes a keyboard tray illumining module 141 and a compartment drawer illumining module 142, wherein the keyboard tray illumining module 141 and the compartment drawer illumining module 142 are disposed on the bottom of the working platform 112. The keyboard tray illumining module 141 is configured to illumine the keyboard tray 132 being pulled out of the cabinet 110, and an effective illumining range of the keyboard tray illumining module 141 is located in the surrounding of the keyboard tray 132 being pulled out of the cabinet 110, as shown in FIG. 2. The compartment drawer illumining module 142 is configured to illumine any one of the compartment drawers 134 being pulled out of the cabinet 110, as shown in FIG. 3. The sensing unit 150 is disposed in the cabinet 110, for sensing whether the keyboard tray 132 or one of the compartment drawers 134 of the drawers 130 is pulled out of the cabinet 110 or not, and the sensing result of the sensing unit 150 is the basis for switching on the keyboard tray illumining module 141 or the compartment drawer illumining module 142 or not. The switch unit 160 is disposed on the top of the working platform 112 to control whether the illumining unit 140 is switched on or not manually.

FIG. 2 is a side view showing a keyboard tray illumining module of the mobile cart illumining a keyboard tray. Referring to FIG. 2, the keyboard tray illumining module 141 can respond to the signal from the sensing unit 150. Thus, when the sensing unit 150 senses the keyboard tray 132 being pulled out of the cabinet 110, the keyboard tray illumining module 141 is switched on to illumine the keyboard tray 132 being pulled out. In an embodiment, once a pulled-out length of the keyboard tray 132 from the cabinet 110 reaches one third of a total length L1 of the keyboard tray 132 or reaches two third of a length L2 of a keyboard disposing area 132a of the keyboard tray 132, the sensing unit 150 generates a signal to switch on the keyboard tray illumining module 141, which prevents an unwanted operation of the user. The directions of the aforementioned pulled-out length, the total length L1, and the length L2 are parallel to a pull direction D of the drawers 130. In the present embodiment, once the sensing unit 150 senses the keyboard tray 132 being pulled out of the cabinet 110, the sensing unit 150 outputs a signal to a control unit 170 so as to switch on the keyboard tray illumining module 141 by the control unit 170. The sensing unit 150 may include a contactless sensor (e.g. an optical sensor) or a contact sensor (e.g. a mechanical switch) for sensing the movement of the keyboard tray 132 relatively to the cabinet 110. In addition, a first optical axis A1 of the keyboard tray illumining module 141 may be inclined toward the pull direction of the drawers 130 with respect to the carrying surface of the keyboard tray 132 or with respect to the ground G where the wheels 120 are located. In other words, a first angle θ1 is formed between the first optical axis A1 and the carrying surface of the keyboard tray 132. In the present embodiment, the first angle θ1 ranges from 15 degrees to 75 degrees, and preferably from 30 degrees to 60 degrees, to improve the illumination effect.

FIG. 3 is a side view showing a compartment drawer illumining module of the mobile cart illumining one of the compartment drawers. Referring to FIG. 3, in the present embodiment, the compartment drawer illumining module 142 can respond to the signal from the sensing unit 150. Hence, when the sensing unit 150 senses one of the compartment drawers 134 being pulled out of the cabinet 110, the compartment drawer illumining module 142 is switched on to illumine the compartment drawer 134 being pulled out of the cabinet 110. In an embodiment, once a pulled-out length of the compartment drawer 134 from the cabinet 110 reaches a half of a total length L3 of the compartment drawer 134, the sensing unit 150 generates a signal to switch on the compartment drawer illumining module 142, which prevents an unwanted operation of the user. The directions of the aforementioned pulled-out length and the total length L3 are parallel to a pull direction D (as shown in FIG. 2) of the drawers 130. In the present embodiment, when the sensing unit 150 senses the compartment drawer 134 being pulled out of the cabinet 110, the sensing unit 150 outputs the signal to the control unit 170 so as to switch on the compartment drawer illumining module 142 by the control unit 170. In addition, a second angle θ2 is formed between a second optical axis A2 of the compartment drawer illumining module 142 and the ground G where the wheels 120 are located. The second angle θ2 ranges from 90 degrees to 120 degrees, and preferably is 90 degrees. In other words, the second optical axis A2 of the compartment drawer illumining module 142 may be perpendicular to the ground G where the wheels 120 are located to improve the illumination effect. The range of the light divergence angle of the compartment drawer illumining module 142 is between 30 degrees and 60 degrees. However, the disclosure does not limit the range of the light divergence angle of the compartment drawer illumining module 142, which may be varied according to using requirement.

In the present embodiment, since the higher drawer 130 (i.e. the keyboard tray 132) is closer to the keyboard tray illumining module 141, while the lower drawer 130 (i.e. the compartment drawer 134) is far away from the keyboard tray illumining module 141 and the compartment drawer illumining module 142, brightness of the keyboard tray illumining module 141 may be less than brightness of the compartment drawer illumining module 142 to comply with practical application and save electric power.

In an embodiment, the mobile cart 100 may further comprise a switch unit 160 disposed on the cabinet 110 (e.g. on the working platform 112 as shown in FIG. 1) and electrically coupled to the keyboard tray illumining module 142 and the compartment drawer illumining module 142. Therefore, the user can trigger the switch unit 160 by fingers to switch on the keyboard tray illumining module 141 for illumining the keyboard tray 132 being pulled out, as shown in FIG. 2, or to switch on the compartment drawer illumining module 142 for illumining the compartment drawer 134 being pulled out, as shown in FIG. 3. In the case of disposing the switch unit 160, the sensing unit 150 may be omitted, and the keyboard tray illumining module 141 and the compartment drawer illumining module 142 can be switched on or off merely by the switch unit 160.

In an embodiment, the sensing result of sensing the higher drawer 130 (i.e. the keyboard tray 132) by the sensing unit 150 can be used to switch the keyboard tray illumining module 141 on or off, while the switch unit 160 can be triggered by the user to switch the compartment drawer illumining module 142 on or off. In an embodiment, the sensing result of sensing the lower drawer 130 (i.e. the compartment drawer 134) by the sensing unit 150 can be used to switch the compartment drawer illumining module 142 on or off, while the switch unit 160 can be triggered by the user to switch the keyboard tray illumining module 141 on or off.

In summary, according to the aforementioned embodiments of the disclosure, the drawer being pulled out of the cabinet can be illumined by the illumining unit in an environment without sufficient illumination, such that the user can see the contents in the drawer clearly to ensure the work can be normally performed. The sensing unit can sense whether the drawer (e.g. the keyboard tray or one of the compartment drawers) is pulled out of the cabinet or not, for switching on the illumining unit to illumine the drawer being pulled out of the cabinet accordingly. The switch unit can also be triggered to switch on the illumining unit to illumine the drawer being pulled out of the cabinet. The illumining unit may include a keyboard tray illumining module and a compartment drawer illumining module for illumining the keyboard tray and the compartment drawers respectively.

It is noted that in the case of applying the disclosure to the mobile cart for medical treatment or nursing, when the mobile cart is moved to the ward where patients rest in the night, the nursing personnel can see the keyboard on the keyboard tray or the medical materials (e.g. drugs and medical equipment) in the compartment drawer clearly by using the illumining unit of the mobile cart to illumine the keyboard tray or the compartment drawer being pulled out of the cabinet, so as to improve precision of medical treatments, reduce risk of medical negligence, and guarantee lives of patients.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A medical cart, comprising:
a cabinet;
a plurality of wheels disposed on a bottom of the cabinet;
a plurality of drawers disposed in the cabinet and configured to be pulled out of the cabinet, wherein the drawers comprise a keyboard tray and a plurality of compartment drawers, and the compartment drawers are located below the keyboard tray for accommodating a plurality of pill boxes;
a keyboard tray illumining module disposed on the cabinet and configured to illumine the keyboard tray pulled out of the cabinet, wherein an effective illumining range of the keyboard tray illumining module is located in the surrounding of the keyboard tray being pulled out of the cabinet; and
a sensing unit disposed on the cabinet for sensing whether the keyboard tray is pulled out of the cabinet or not, wherein the sensing result of the sensing unit is a basis for switching on the keyboard tray illumining module or not, and when the sensing unit senses the keyboard tray being pulled out of the cabinet, the keyboard tray illumining module is switched on to illumine the keyboard tray being pulled out of the cabinet.

2. The medical cart as claimed in claim 1, wherein once a pulled-out length of the keyboard tray from the cabinet reaches one third of a total length of the keyboard tray, the keyboard tray illumining module is switched on, and directions of the pulled-out length and the total length are parallel to a pull direction of the drawers.

3. The medical cart as claimed in claim 1, wherein once a pulled-out length of the keyboard tray from the cabinet reaches two third of a length of a keyboard disposing area of the keyboard tray, the keyboard tray illumining module is switched on, and directions of the pulled-out length and the length of the keyboard disposing area are parallel to a pull direction of the drawers.

4. A mobile cart, comprising:
a cabinet;
a plurality of wheels disposed on a bottom of the cabinet;
a plurality of drawers disposed in the cabinet and configured to be pulled out of the cabinet, wherein the drawers comprise a plurality of compartment drawers; and
an illumining unit disposed on a top of the cabinet and comprising a compartment drawer illumining module, wherein the compartment drawer illumining module is configured to illumine any one of the compartment drawers being pulled out of the cabinet.

5. The mobile cart as claimed in claim 4, wherein the plurality of drawers further comprises a keyboard tray, the illumining unit further comprises a keyboard tray illumining module, the compartment drawers are located below the keyboard tray, and the keyboard tray illumining module is configured to illumine the keyboard tray being pulled out of the cabinet.

6. The mobile cart as claimed in claim 5, further comprising:
a sensing unit disposed on the cabinet to sense whether one of the drawers is pulled out of the cabinet or not, wherein the sensing result of the sensing unit is a basis for switching on the illumining unit or not, when the sensing unit senses the keyboard tray being pulled out of the cabinet, the keyboard tray illumining module is switched on to illumine the keyboard tray being pulled out of the cabinet, and when the sensing unit senses one of the compartment drawers being pulled out of the cabinet, the compartment drawer illumining module is switched on to illumine the compartment drawer being pulled out of the cabinet.

7. The mobile cart as claimed in claim 5, further comprising:
a switch unit disposed on the cabinet for controlling the illumining unit being switched on or not manually, wherein when the switch unit is triggered, the compartment drawer illumining module or the keyboard tray illumining module is switched on.

8. The mobile cart as claimed in claim 5, further comprising:
a sensing unit disposed on the cabinet to sense whether the keyboard tray is pulled out of the cabinet or not, wherein when the sensing unit senses the keyboard tray being pulled out of the cabinet, the keyboard tray illumining module is switched on to illumine the keyboard tray being pulled out of the cabinet; and
a switch unit disposed on the cabinet for controlling the compartment drawer illumining module being switched on or not manually, wherein when the switch unit is triggered, the compartment drawer illumining module is switched on.

9. The mobile cart as claimed in claim 8, wherein the cabinet has a working platform located above the keyboard tray, the illumining unit is disposed on a bottom of the working platform, and the switch unit is disposed on a top of the working platform.

10. The mobile cart as claimed in claim 5, wherein an optical axis of the keyboard tray illumining module is inclined with respect to a ground where the wheels are located, and an optical axis of the compartment drawer illumining module is perpendicular to the ground where the wheels are located.

11. The mobile cart as claimed in claim 4, further comprising a sensing unit disposed on the cabinet for sensing whether one of the compartment drawers is pulled out of the cabinet or not, wherein the sensing result of the sensing unit is a basis for switching on the compartment drawer illumining module or not, once a pulled-out length of the compartment drawer from the cabinet reaches a half of a total length of the compartment drawer, the compartment drawer illumining module is switched on according to the sensing result of the sensing unit to illumine the compartment drawer being pulled out of the cabinet, and directions of the pulled-out length and the total length are parallel to a pull direction of the drawers.
